(19) United States
(12) Patent Application Publication
(10) Pub. No.: US 2002/0089999 A1
(43) Pub. Date: Jul. 11, 2002

(54) Method for double-ended line qualification and monitoring of xDSL links

(75) Inventor: Stephan Binde, Baierbrunn (DE)

Correspondence Address: STAAS & HALSEY LLP, 700 11TH STREET, NW, SUITE 500, WASHINGTON, DC, 20001, US

(73) Assignee: Siemens Aktiengesellschaft of Munich

(21) Appl. No.: 10/036,502

(22) Filed: Jan. 7, 2002

(30) Foreign Application Priority Data
Jan. 9, 2001 (DE) 10100607.1

(51) Int. Cl. H04J 3/16

(52) U.S. Cl. 370/465; 370/241

(57) ABSTRACT

A method for double-ended line qualification and monitoring of xDSL links employs a single test program which is sent by a first subscriber at one end of the xDSL link to a second subscriber at the other end of the xDSL link. Line qualification and/or monitoring is carried out by processing this test program and sending the test results obtained in this step back to the first subscriber. The line qualification and/or monitoring is triggered after the code of the test program has been transmitted by the first subscriber. In this method, the first subscriber represents a modem at the switching end and the second subscriber represents a modem at the subscriber end. The test program is a program module which is connected to other program modules via a message queue.

### CROSS REFERENCE TO RELATED APPLICATIONS

This application is based on and hereby claims priority to German Application No. 10100607.1 filed on Jan. 9, 2001 in Germany, the contents of which are hereby incorporated by reference.

### BACKGROUND OF THE INVENTION

The present invention relates to a method for the double-ended line qualification and monitoring of xDSL links.

During the installation of high-bit-rate xDSL lines, it is desirable for the operator to receive information on the state of the line 3 (FIG. 2). There have previously not yet been any suitable methods for performing a reliable line qualification with respect to the criteria of line quality, line length, upstream and downstream data rates etc. in the data path 5 for xDSL. More precisely, it is not yet possible at the present time to gain full access to the modem 2 at the subscriber end from the modem 1 at the switch end, and thus to perform double-ended line diagnostics and monitoring.

There are only unilateral line tests in the voice path 4. In this method, a sequence of test functions are sent out by the switch end and the signals received thereupon are evaluated. Thus, it is possible to draw conclusions about resistance and capacity loading on the line 3 via current and voltage measurements, and thus to test roughly the operability of the line in the low-frequency voice path 4 (up to 4 kHz). An accurate analysis for the data path 5, particularly including evaluation of bit rates to be expected, is not possible by this method.

Generalizing of the voice path tests to the higher-frequency data path 5 (up to 1.1 MHz) presents problems since the line attenuation at high frequencies is already so strong that an evaluation of the line parameters from the reflected received signal is no longer possible with sufficient accuracy. In addition, if the modem 2 at the subscriber end is connected to the line, the line is approximately terminated with its characteristic impedance so that reflections are largely suppressed.

Against this background, only double-ended approaches which generate and evaluate test signals both in the modem at the switching end and in the modem at the subscriber end, are suitable for line diagnostics and monitoring.

It is, therefore, one potential object of the present invention to provide a method which provides for simpler and more efficient line diagnostics and monitoring.

### SUMMARY OF THE INVENTION

This object may be achieved with a method in which a single test software, which is sent by a first subscriber at one end of the xDSL link (modem at the switching end) to a second subscriber at the other end of the xDSL link is used for the double-ended line qualification and/or monitoring of xDSL links and the line qualification and/or monitoring is carried out by processing this test software and sending the test results obtained in this step back to the first subscriber.

The line qualification and/or monitoring is triggered after the code of the test software has been transmitted by the first subscriber.

In this arrangement, the first subscriber represents a modem at the switching end and the second subscriber represents a modem at the subscriber end.

The test software is a program module which is connected to other program modules via a message queue.

The test software is used both for diagnostics and for real-time interpretation of the xDSL link.

Line qualification and/or monitoring can also be carried out by processing this test software at the end of the first subscriber.

xDSL links are characterized especially by the fact that the modem at the switching end and the modem at the subscriber end form virtually one unit. The modem at the switching end is matched to the modem at the subscriber end and, in general, it even contains the same chip set so that a software solution always relates to both ends of the line. According to one aspect of the invention, the modem at the subscriber end can be considered as a type of out station of the modem at the switching end and thus belongs in the area of responsibility of the service provider. This provides the advantage of transparency for the network operator. He can install in the modem at the subscriber end anything that appears necessary to him without being dependent on the customer.

The xDSL link can be constructed, for example, as ADSL, UDSL or SDSL link.

In the ADSL standard (T1.413 or, respectively, G992.1), establishing a connection between the modem at the switching end and the modem at the subscriber end is specified, but no complete remote control of the modem at the subscriber end at the level of the physical transmission parameters. This means, that the modem at the subscriber end cannot be caused to send out arbitrary test signals and to send received measuring sequences back to the modem at the switching end.

The concept according to one aspect of the invention, in contrast, provides the advantage of a “solution from one source”: a test software for line diagnostics is installed at the modem at the switching end and the matching version for the modem test at the subscriber end is installed by downloading at the modem at the subscriber end. Updating is up to the service provider and can be carried out by him at any time without having to include the customer in the process. This means that control and monitoring of the xDSL link is completely in the hands of the network operator by the method presented in the text which follows.

### BRIEF DESCRIPTION OF THE DRAWINGS

exemplary embodiments and referring to the accompanying drawings, in which:] These and other objects and advantages of the present invention will become more apparent and more readily appreciated from the following description of the preferred embodiments, taken in conjunction with the accompanying drawings of which:

FIG. 1 represents the test method for testing the data link between a modem at the switching end and a modem at the subscriber end as a program module (task),

FIG. 2 diagrammatically shows the transmission link to be qualified, and

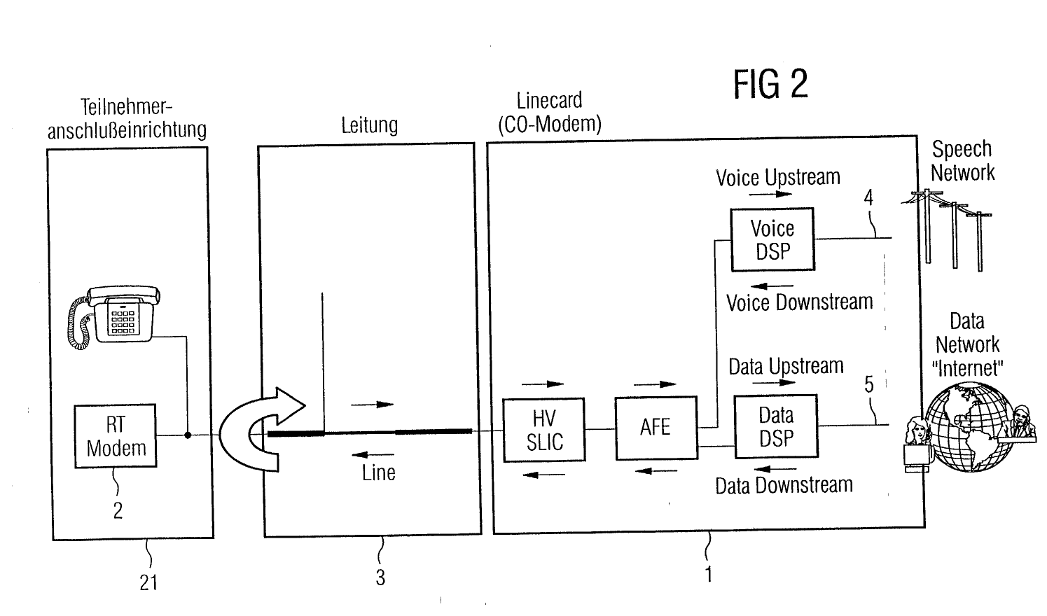

FIG. 3 represents a modem at the switching end according to the related art.

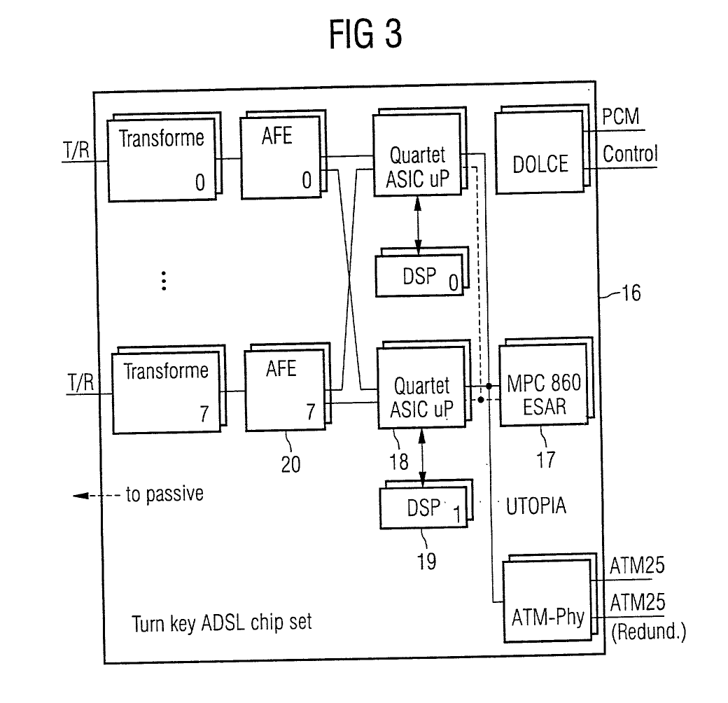

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

To explain the method, the following two scenarios are assumed which could result during the testing of the data link between the modem at the switching end and the modem at the subscriber end:

I) The xDSL link is interrupted and it is not possible to set up (start up) a connection between the two modems.

II) The xDSL link is operable in principle but transmission is not taking place at the full data rate.

Re. I): In this case, the connection to the modem at the subscriber end is open. Only unilateral line tests will assist in obtaining information on the error pattern. For example, the line test in the voice path can provide information on whether the line is broken or whether the connection has been interrupted at the subscriber end.

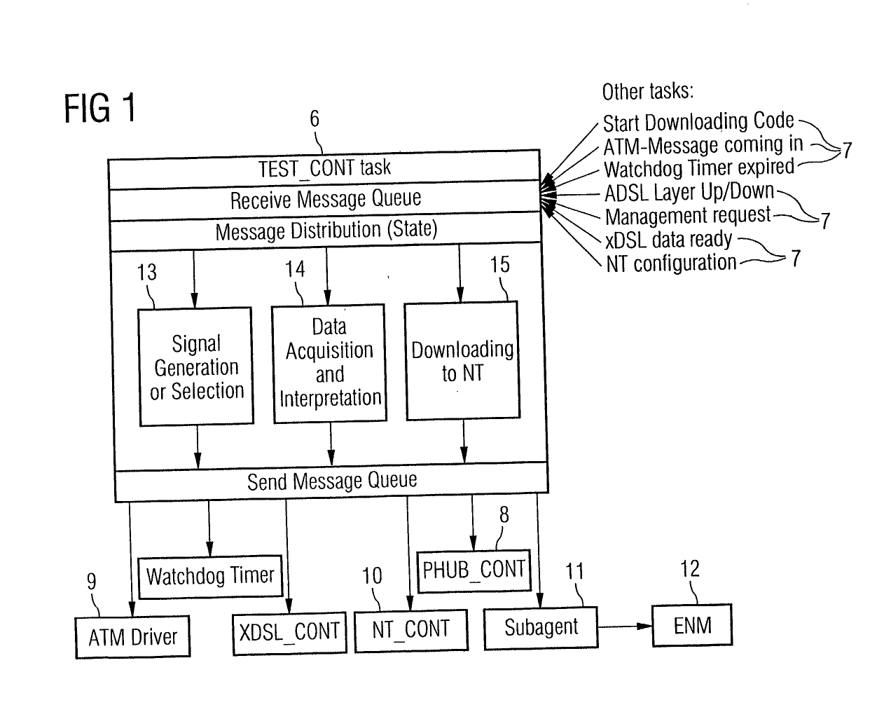

Re. II): This is the actual application for the test method for testing the line in the high-bit-rate area according to one aspect of the invention. It will be described below with reference to FIG. 1.

The test method can be represented as a program module 6 (task) which is connected to other program modules 7 (tasks) under an operating system (e.g. VxWorks) via message queues. This program module 6 can thus initiate a downloading of the test software via task PHUB_CONT 8. Control commands for the test routines can be delivered to the modem at the subscriber end via the ATM (asynchronous transfer mode) driver 9. The modem at the subscriber end can be initialized via the task NT_CONT 10. The data measured in the modem at the subscriber end can also be transmitted via the ATM driver 9 (in the upstream direction, i.e. from the modem at the subscriber end to the modem at the switching end) to a routine TEST_CONT 6, where they are evaluated.

The routine TEST_CONT 6 has diagnostic and interpretation functions and is structured as follows:

A) Diagnostic Functions

For the diagnostics, the following measurements can be carried out in the downstream direction (from the modem at the switching end to the modem at the subscriber end) and in the upstream direction (from the modem at the subscriber end to the modem at the switching end):

data streams which are transmitted in the downstream direction, i.e. from the modem at the switching end, and are measured and evaluated by the modem at the subscriber end:

sending test signals to qualify the line by these means,

sending reflection signals (broadband signals which can test the line in as many frequency bands as possible) of the modem at the switching end to the modem at the subscriber end for measuring the line frequency response in the downstream direction,

measuring the idle-channel noise level in the downstream direction (i.e. when there is no excitation signal)

measuring the signal-to-noise ratio (SNR)

channel impulse response in the downstream direction

setting up the xDSL link and reading out relevant information in the downstream direction from the xDSL-MIB (Management Instruction Base)

Exception: during the measurement of the echo signal in the downstream direction, the reflected echo is evaluated by the emitting unit, i.e. the modem at the switching end.

Data streams which are sent in the upstream direction, that is to say from the modem at the subscriber end and are measured and evaluated by the modem at the switching end:

sending test signals to the modem at the switching end for line qualification

reflection signals for measuring the line frequency response in the upstream direction

measuring the idle-channel noise level in the upstream direction (i.e. when there is no excitation signal)

measuring the signal-to-noise ratio (SNR)

channel impulse response in the upstream direction

setting up the xDSL link and reading out relevant information in the upstream direction from the XDSL-MIB

Exception: during the measurement of the echo signal in the upstream direction, the reflected echo is measured and evaluated by the emitting unit, i.e. the modem at the subscriber end.

While the measurements in the downstream direction can be initiated directly by the modem at the switching end, the measurements in the upstream direction must be initiated by downloading a test software (code-download) to the modem at the subscriber end. This test software can be loaded together with the modem software (modem data pump) which allows a simultaneous monitoring function to be started in addition to the line qualification. The results of the downstream measurement must be transmitted to the modem at the switching end by transmitting the data so that they can be further evaluated there. Apart from a double-ended line analysis, each modem can also perform a unilateral analysis of the line, and the results of the modem at the subscriber end must then be reported in the same manner to the modem at the switching end for further interpretation.

B) Interpretation Functions

From the collected data the task TEST_CONT in the modem at the switching end then determines the following characteristics:

line quality

line length

upstream and downstream data rates

number and position of branch lines which branch off the line at various points and cause unwanted reflections (bridged taps)

discrete interference sources and

other line characteristics

Evaluation and qualification of the data for line diagnostics and monitoring are performed by the task TEST_CONT and are forwarded by (alarm) traps (messages which are forwarded from the modem at the switching end to the network management in the case of a fault) via subagent 11 to the management system (ENM—Enhanced Network Management). The subagent is the communication unit in the modem at the switching end which establishes a connection with the master agent at a higher level via SNMP (Simple Network Management Protocol). The software modules in the modem at the switching end are controlled by SNMP.

Thus, the line can be monitored and when disturbances occur, error messages can be reported to the network management in real-time.

Both diagnostics and interpretation can be implemented by the “Signal Generation and Selection” 13, “Data Acquisition and Interpretation” 14 and “Downloading to NT” 15 modules in the task TEST_CONT. The task TEST_CONT is controlled by incoming messages from other tasks and, in turn, sends outgoing messages to other tasks.

The method provides the ability to control a double-ended line qualification and monitoring as integrated approach to a solution from a central point (in the modem at the switching end). Whereas accurate line surveillance has previously only been possible by two measuring instruments (first test instrument in the modem at the switching end and second test instrument in the modem at the subscriber end)—or in more recent approaches by two test software solutions (first diagnostic software in the modem at the switching end and second diagnostic software in the modem at the subscriber end)—the line qualification of xDSL links according to the method allows for complete diagnostics and monitoring of the data link from one source. Only a diagnostic software in the modem at the switching end is required which automatically initiates a downloading to the modem at the subscriber end in order to be able to carry out the required tests for monitoring and diagnostic of the xDSL link.

In the modem at the subscriber end, this requires a separate test module which establishes communication with the test software in the modem at the switching end. This test module can be transferred to the modem at the subscriber end by downloading under control from the modem at the switching end. It is then located virtually as a piggy back module on the actual modem software of the modem at the subscriber end and is caused to change into test mode by separate control functions from the modem at the switching end, to measure the xDSL link and to transmit results back to the modem at the switching end.

The entire xDSL link can thus be considered to be one unit which is accessible from both ends. This eliminates elaborate service methods for ensuring the quality of service. The link becomes more transparent for the operator since all of its components can be controlled from his end. The integrated test concept can be inserted into existing software solutions with little expenditure and allows efficient line diagnostics and monitoring of xDSL links. It should be possible to carry out the software implementation without great expenditure.

In the case where the modem at the subscriber end does not have a downloading capability, the principle of the method described above can also be implemented in a simplified manner as will be explained below:

To measure the upstream link, instead of downloading, the modem code is activated which places the modem at the subscriber end into a state in which it generates signals which are suitable for testing the line. These are, for example, the signals generated during the training of the ADSL link (R-ACT-REQ, R-QUIET, R-REVERB1-6, R-SEGUE1,2, R-MEDLEY, . . . ) Since these signals are precisely specified in the ADSL standard, the CO modem can perform an accurate analysis in the upstream path from the measured data.

During the training, the line, including the local loop device 21, is accurately measured in order to obtain information on the signal-to-noise ratio in the various frequency bands. These results are used for determining the number of bits which can be transmitted in what frequency bins and how the bit loading is to be performed.

To evaluate the downstream link, the information can be used which is stored in the ADSL-MIB (Management Information Base) and the SLMU-MIB (Subscriber Line Module—MIB) at the switching end according to the related art.

In the ADSL-MIB and the SLMU-MIB, a multiplicity of data are stored which characterize the upstream and downstream data links. Standardized basic information is stored here such as, for example, the characteristics “Current Tx Rate”, “Current Output Power”, “Current SNR margin”, “Current Attenuation”, “Loss of frame”, “Loss of signal”, “HEC error counter” etc.

The simplest way of implementing the method is to read the required data out of the two MIBs of the modem at the switching end in order to reach a subset of data which are required for the interpretation functions.

It is not possible to utilize the complete interpretation functions with such a subset of information as would be possible with complete arbitrary recorded impulse responses or transfer functions.

By comparison, downloading the software of the modem at the switching end has advantages. For this purpose, the controller 17 of the modem at the subscriber end and of the modem at the switching end, respectively, is only informed that a new modem software for line diagnostics which has its own code number and a separate checksum so that the controller 17 forwards the new modem software to the DSP (Digital Signal Processor). To evaluate the data, the controller 17 will then have to forward the required data to the task TEST_CONT.

The line monitoring and diagnostic system introduced here is available as an ideal supplement to ADSL data communication in order to be able to provide the service provider with additional quality of service within existing solutions without great additional expenditure.

The invention has been described in detail with particular reference to preferred embodiments thereof and examples, but it will be understood that variations and modifications can be effected within the spirit and scope of the invention.

What is claimed is:

1. A method for double-ended line qualification and monitoring of xDSL links, comprising:
transmitting a test program from a first subscriber at one end of the xDSL link to a second subscriber at the other end of the xDSL link,
execution of the line qualification and/or monitoring by this second subscriber by processing this test program and
sending the test results already obtained back to the first subscriber.

2. The method as claimed in claim 1, wherein the line qualification and/or monitoring is triggered after the code of the test program has been transmitted by the first subscriber.

3. The method as claimed in claim 1, wherein the first subscriber represents a modem at the switching end.

4. The method as claimed in claim 1, wherein the second subscriber represents a modem at the subscriber end.

5. The method as claimed in claim 1, wherein the test program represents a program module which is connected to other program modules via a message queue.

6. The method as claimed in claim 1, wherein the test program is used both for diagnostic and for real-time interpretation of the xDSL link.

7. The method as claimed in claim 1, wherein a line qualification and/or monitoring can also be carried out at the end of the first subscriber by processing this test program.

8. The method as claimed in claim 1, wherein the xDSL link can be an ADSL, a UDSL or an SDSL link.

9. A method for double-ended line qualification and monitoring of xDSL links comprising:
activating a text program of a second subscriber at one end of the xDSL link from a first subscriber by a command which causes the second subscriber to generate signals which are suitable for testing the line,
execution of the line qualification and/or monitoring by the second subscriber by processing the test program of the second subscriber, and
sending the test results obtained back to the first subscriber.

10. The method as claimed in claim 9, wherein the signals generated by the second subscriber are the signals which are generated during the training of the xDSL link.

11. The method as claimed in claim 9, wherein the data necessary for line qualification and monitoring are read out of a memory of the modem at the subscriber end or modem at the switching end, which contains a multiplicity of data which characterize the upstream and downstream data link, respectively.
